(19) United States
(12) Patent Application Publication
(10) Pub. No.: US 2024/0322420 A1
(43) Pub. Date: Sep. 26, 2024

(54) ANTENNA DEVICE AND IC CARD HAVING THE SAME

(71) Applicant: TDK Corporation, Tokyo (JP)

(72) Inventors: Shoma KAJIKIYA, Tokyo (JP); Tomohiro MORIKI, Tokyo (JP); Yoshitomo SATO, Tokyo (JP); Toshio TOMONARI, Tokyo (JP)

(21) Appl. No.: 18/608,680

(22) Filed: Mar. 18, 2024

(30) Foreign Application Priority Data
Mar. 20, 2023 (JP) 2023-044248
Mar. 20, 2023 (JP) 2023-044249

(51) Int. Cl. H01Q 1/22; H01Q 7/00

(52) U.S. Cl. CPC H01Q 1/2283; H01Q 7/005

(57) ABSTRACT

Disclosed herein is an antenna device that includes a metal plate having a slit, a first coil, and a second coil disposed inside an opening of the first coil and connected to the first coil. The first end of the slit is opened so as to divide an outer edge of the metal plate. The second end of the slit is terminated at a position away from the outer edge of the metal plate by a first distance so as not to divide the outer edge of the first metal plate. The slit includes a first section overlapping the second coil, a second section positioned between the first section and the first end, and a third section positioned between the first section and the second end. The first distance is smaller than a longer one of the second and third sections.

### CROSS-REFERENCE TO RELATED APPLICATION

This application claims the benefit of Japanese Patent Application No. 2023-044248, filed on Mar. 20, 2023 and Japanese Patent Application No. 2023-044249, filed on Mar. 20, 2023, the entire disclosures of which are incorporated by reference herein.

### BACKGROUND

The present disclosure relates to an antenna device and an IC card having the same.

U.S. Patent Publication No. 2021/0350198 discloses an IC card whose both surfaces are constituted by a metal plate.

### SUMMARY

An antenna device according to one embodiment of the present disclosure includes: a first metal plate; a first coil disposed so as to overlap the first metal plate in a plan view and wound along an outer edge of the first metal plate; and a second coil disposed inside an opening of the first coil and connected to the first coil, wherein the first metal plate has a slit extending in a longer length direction of the first metal plate, wherein the slit has first and second ends positioned at both ends in the longer length direction, wherein the first end is opened so as to divide an outer edge of the first metal plate, wherein the second end is terminated at a position away from the outer edge of the first metal plate by a first distance so as not to divide the outer edge of the first metal plate, wherein the slit includes a first section overlapping the second coil, a second section positioned between the first section and the first end, and a third section positioned between the first section and the second end, and wherein the first distance is smaller than a longer one of the second and third sections.

An antenna device according to another embodiment of the present disclosure includes: a first metal plate; a first coil disposed so as to overlap the first metal plate in a plan view; and a second coil disposed inside an opening of the first coil and connected to the first coil, wherein the first metal plate has a slit extending in a longer length direction of the first metal plate, wherein the slit has first and second ends positioned at both ends in the longer length direction, wherein the first end is opened so as to divide an outer edge of the first metal plate, wherein the second end is terminated at a position away from the outer edge of the first metal plate by a first distance so as not to divide the outer edge of the first metal plate, wherein the slit includes a first section overlapping the second coil, a second section positioned between the first section and the first end, and a third section positioned between the first section and the second end, wherein a part of the first coil extends in the longer length direction along at least one of the second and third sections of the slit, and wherein an inside area of the first metal plate that overlaps the opening of the first coil is smaller than an outside area of the first metal plate that does not overlap the opening of the first coil.

An antenna device according to a still another embodiment of the present disclosure includes: a first metal plate; and a second metal plate overlapping the first metal plate, wherein the first metal plate has a first slit extending in a longer length direction of the first metal plate, wherein the first slit has first and second ends positioned at both ends in the longer length direction, wherein the first end of the first slit is opened so as to divide an outer edge of the first metal plate, wherein the second end is terminated at a position away from the outer edge of the first metal plate by a first distance so as not to divide the outer edge of the first metal plate, wherein the second metal plate has a through hole therein and a second slit connecting an outer edge of the second metal plate with the through hole, wherein the first slit includes a first section overlapping the through hole, a second section positioned between the first section and the first end, and a third section positioned between the first section and the second end, and wherein the first distance is smaller than a longer one of the second and third sections.

### BRIEF DESCRIPTION OF THE DRAWINGS

The above features and advantages of the present disclosure will be more apparent from the following description of certain preferred embodiments taken in conjunction with the accompanying drawings, in which:

FIG. 1 is a schematic perspective view illustrating the outer appearance of an IC card 3 according to one embodiment of the present disclosure having an antenna device;

FIG. 2 is schematic exploded perspective view for explaining the structure of the IC card 3;

FIG. 3 is a schematic cross-sectional view for explaining the structure of the IC card 3;

FIG. 4 is a schematic plan view of the bottom metal plate 10 constituting the antenna device 1;

FIG. 5 is a schematic plan view of the conductor patterns formed on the first main surface 21 of the substrate 20 in the antenna device 1;

FIG. 6 is a schematic plan view of the conductor patterns formed on the second main surface 22 of the substrate 20 in the antenna device 1;

FIG. 7 is an equivalent circuit diagram of the antenna device 1;

FIG. 8 is an equivalent circuit diagram of the antenna device according to a modification;

FIG. 9 is a schematic plan view illustrating a state where the bottom metal plate 10 and substrate 20 overlap each other in the antenna device 1; 20 FIG. 10 is a schematic perspective view of the IC module 50 as viewed from the back surface side thereof;

FIG. 11 is a schematic diagram showing a state in which the IC card 3 and the card reader 6 communicate;

FIG. 12 is a schematic plan view of the bottom metal plate 10 according to a modification;

FIG. 13 is a schematic exploded perspective view for explaining the structure of an IC card 4 having an antenna device 2 according to a second embodiment of the present disclosure;

FIG. 14 is a schematic plan view of the bottom metal plate 10 used for the antenna device 2;

FIG. 15 is a schematic exploded perspective view for explaining the structure of an IC card 7;

FIG. 16 is a schematic cross-sectional view for explaining the structure of an IC card 7;

FIG. 17 is a schematic plan view of the conductor patterns formed on the first main surface 21 of the substrate 20 in the antenna device 5;

FIG. 18 is a schematic plan view of the conductor patterns formed on the second main surface 22 of the substrate 20 in the antenna device 5;

FIG. 19 is a schematic plan view illustrating a state where the bottom metal plate 10 and substrate 20 overlap each other in the antenna device 5;

FIG. 20 is schematic plan view of the conductor patterns formed on the first main surface 21 of the substrate 20 when the bottom metal plate 10 according to a modification is used;

FIG. 21 is schematic plan view of the conductor patterns formed on the second main surface 22 of the substrate 20 when the bottom metal plate 10 according to the modification is used; and

FIG. 22 is a schematic plan view illustrating a state where the bottom metal plate 10 illustrated in FIG. 12 and the substrate 20 illustrated in FIGS. 20 and 21 overlap each other.

### DETAILED DESCRIPTION OF THE EMBODIMENTS

An object of the present disclosure is to provide an antenna device suitable for an IC card whose both surfaces are constituted by a metal plate.

Some embodiments of the present disclosure will be explained below in detail with reference to the accompanying drawings.

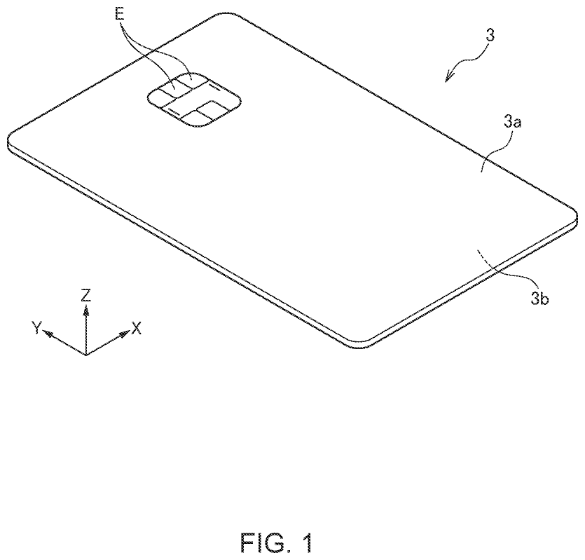

FIG. 1 is a schematic perspective view illustrating the outer appearance of an IC card 3 according to one embodiment of the present disclosure having an antenna device.

As illustrated in FIG. 1, the IC card 3 according to the present embodiment has a plate-like shape in which the Y-, X-, and Z-directions are defined as the longer length direction, shorter length direction, and thickness direction, respectively, and has an upper surface 3a and a back surface 3b which constitute the XY plane. The IC card 3 incorporates therein an IC module to be described later whose terminal electrode E is exposed to the upper surface 3a of the IC card 3.

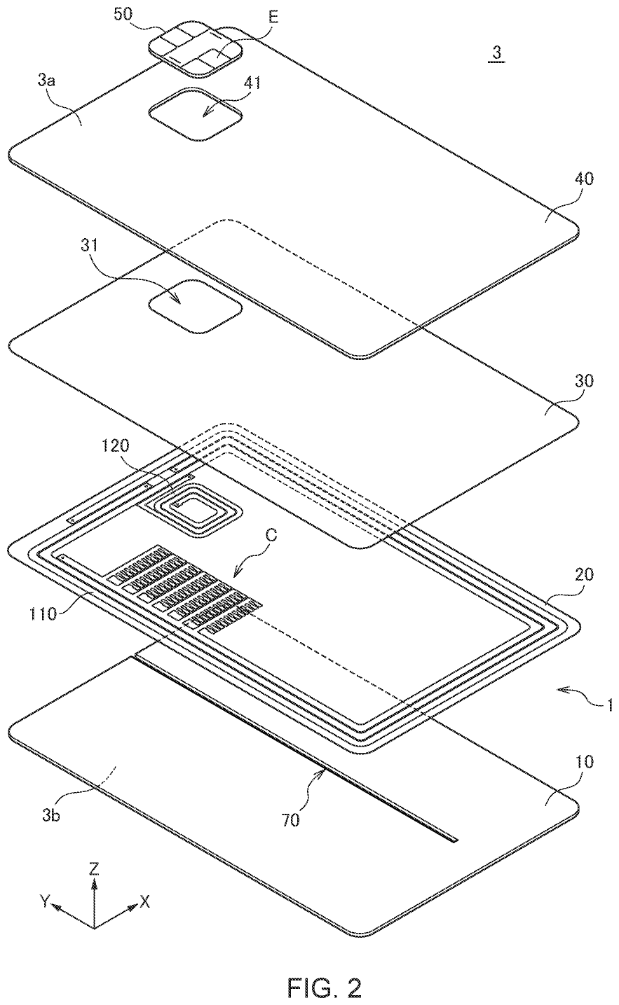

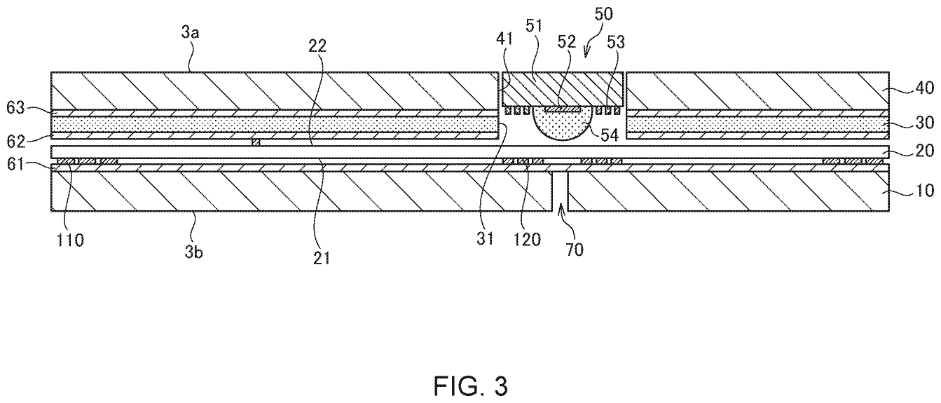

FIGS. 2 and 3 are respectively a schematic exploded perspective view and a schematic cross-sectional view for explaining the structure of the IC card 3 having an antenna device 1 according to a first embodiment of the present disclosure.

The IC card 3 illustrated in FIGS. 2 and 3 has a structure in which a bottom metal plate 10, a substrate 20, a magnetic body 30, and a top metal plate 40 are laminated in this order from the back surface 3b side to the upper surface 3a side. The bottom metal plate 10 constitutes a first metal plate, and the surface thereof constitutes the back surface 3b of the IC card 3. The top metal plate 40 constitutes a second metal plate, and the surface thereof constitutes the upper surface 3a of the IC card 3. The top metal plate 40 and bottom metal plate 10 are each made of a metal material such as stainless steel or titanium. The top metal plate 40 has a through hole 41 in which an IC module 50 is disposed. Thus, the IC card 3 is a card whose upper and back surfaces are constituted by the metal plates.

The substrate 20 is a film made of an insulating resin material and has conductor patterns on first and second main surfaces 21 and 22 which are positioned on mutually opposite sides. The conductor patterns provided on the substrate 20 include a first coil 110 and a second coil 120. The antenna device 1 according to the present embodiment is constituted by at least the bottom metal plate 10, first coil 110, and second coil 120. The bottom metal plate 10 mainly functions as an antenna that communicates with external devices using electromagnetic coupling, the first coil 110 mainly functions as a resonance circuit electromagnetically coupled to the bottom metal plate 10, and the second coil 120 mainly functions as a coupling coil electromagnetically coupled to the IC module 50. In the present embodiment, the first and second coils 110 and 120 are sandwiched between the bottom metal plate 10 and the top metal plate 40.

A conductive material constituting the conductor patterns may be copper, aluminum, or an alloy thereof, for example. The insulating resin material constituting the film-like substrate 20 may be PET (Polyethylene Terephthalate), PI (Polyimide), or the like. The first main surface 21 of the substrate 20 faces the bottom metal plate 10, and the second main surface 22 of the substrate 20 faces the top metal plate 40 through the magnetic body 30. The bottom metal plate 10 and substrate 20 are stuck to each other through an adhesive layer 61.

The second main surface 22 of the substrate 20 is covered with the magnetic body 30. The magnetic body 30 may be a sheet-like member or a coated body coated onto the second main surface 22 of the substrate 20. When the magnetic body 30 is a sheet-like member, the magnetic body 30 and substrate 20 are stuck to each other through an adhesive layer 62 as illustrated in FIG. 3. When the magnetic body 30 is a coated body coated onto the second main surface 22 of the substrate 20, the magnetic body 30 and substrate 20 are directly stuck to each other without an adhesive layer. The magnetic body 30 is stuck to the top metal plate 40 through an adhesive layer 63. The magnetic body 30 has a through hole 31 at a position overlapping the through hole 41 formed in the top metal plate 40.

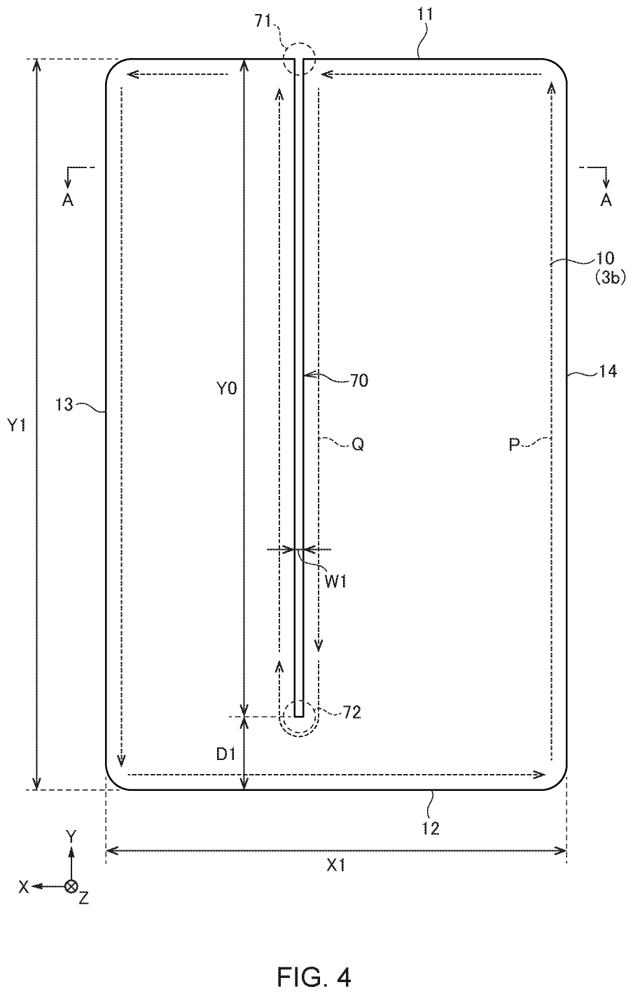

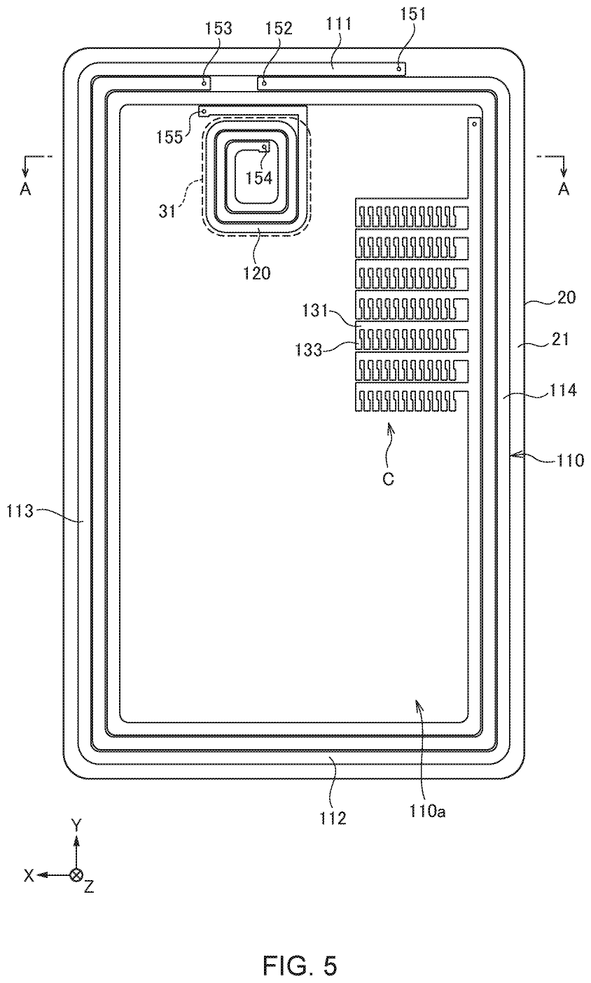

FIG. 4 is a schematic plan view of the bottom metal plate 10 constituting the antenna device 1. The line A-A illustrated in FIG. 4 indicates the sectional position in FIG. 3. The same applies to FIGS. 5, 6, and 9.

As illustrated in FIG. 4, the bottom metal plate 10 has outer edges 11 and 12 extending in the X-direction (shorter length direction) and facing each other in the Y-direction (longer length direction) and outer edges 13 and 14 extending in the Y-direction (longer length direction) and facing each other in the X-direction (shorter length direction). The length of the bottom metal plate 10 in the X-direction is X1, and the length thereof in the Y-direction is Y1. The bottom metal plate 10 further has a slit 70 extending in the Y-direction. The slit 70 has a constant width W1 in the X-direction. That is, the slit 70 does not have a widened part where the width in the X-direction locally increases. Further, the slit 70 is not positioned at the center in the X-direction but offset to the outer edge 13 side. It should be noted that the “constant” includes an error caused due to manufacturing variations.

The slit 70 has first and second ends 71 and 72 positioned at both ends in the Y-direction. The first end 71 is opened so as to divide the outer edge 11, while the second end 72 does not reach the outer edge 12 and is terminated at a position away from the outer edge 12 by a first distance D1. The first distance D1 is sufficiently smaller than the length Y1 of the bottom metal plate 10 in the Y-direction and is not more than half or less of the length Y1. That is, a length Y0 of the slit 70 in the Y-direction is sufficiently large and is not less than half or more of the length Y1 of the bottom metal plate 10 in the Y-direction. The length of the slit 70 in the Y-direction may be two-thirds or more, three-fourths or more, and four-fifths or more of the length Y1. In the example illustrated in FIG. 4, the length Y0 of the slit 70 in the Y-direction is about nine-tenths of the length Y1.

FIG. 5 is a schematic plan view of the conductor patterns formed on the first main surface 21 of the substrate 20.

As illustrated in FIG. 5, the first main surface 21 of the substrate 20 has thereon the first coil 110, second coil 120, and capacitor patterns 131 and 133. The first coil 110 is a pattern wound in about three turns along the outer edge of the substrate 20, and the second coil 120 and capacitor patterns 131 and 133 are disposed in an opening 110a of the first coil 110. The first coil 110 has sections 111 and 112 extending in the X-direction along the respective outer edges 11 and 12 of the bottom metal plate 10 and sections 113 and 114 extending in the Y-direction along the respective outer edges 13 and 14 of the bottom metal plate 10. The second coil 120 is disposed at a position overlapping the through hole 31 of the magnetic body 30. In the example illustrated in FIG. 5, the number of turns of the second coil 120 is also about three.

The capacitor pattern 131 is a pattern branched in the X-direction from the innermost turn of the first coil 110. In the example illustrated in FIG. 5, seven capacitor patterns 131 are branched from the innermost turn of the first coil 110; however, the number of the capacitor patterns 131 is not particularly limited. Further, a plurality of the capacitor patterns 133 are branched from one capacitor pattern 131. The capacitor patterns 133 all extend in the Y-direction. In the example illustrated in FIG. 5, twelve capacitor patterns 133 are branched from the capacitor pattern 131; however, the number of the capacitor patterns 133 is not particularly limited.

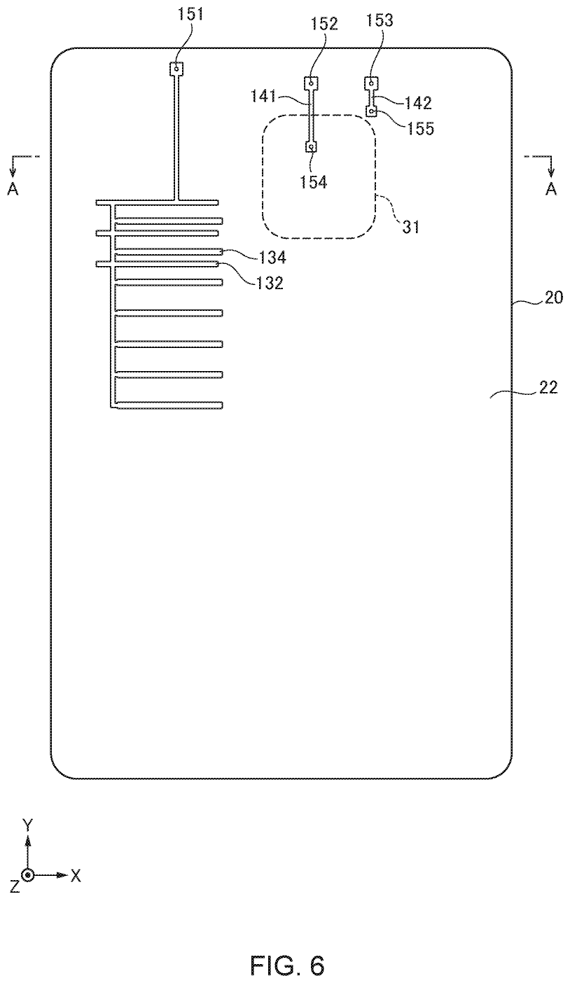

FIG. 6 is a schematic plan view of the conductor patterns formed on the second main surface 22 of the substrate 20.

As illustrated in FIG. 6, the second main surface 22 of the substrate 20 has thereon capacitor patterns 132, 134 and connection patterns 141, 142. The planar positions of the capacitor patterns 132 and 134 coincide with those of the capacitor patterns 131 and 133, respectively. That is, the capacitor patterns 131 and 132 are opposed to each other through the substrate 20, and the capacitor patterns 133 and 134 are opposed to each other through the substrate 20. Thus, the capacitor patterns 131, 133 provided on the first main surface 21 of the substrate 20, the capacitor patterns 132, 134 provided on the second main surface 22 of the substrate 20, and the substrate 20 positioned therebetween constitute a capacitor C. The capacitance of the capacitor C having such a pattern shape can be finely adjusted by removing some of the capacitor patterns 133 by trimming.

As illustrated in FIGS. 5 and 6, the outer peripheral end of the first coil 110 is connected to the capacitor patterns 132 and 134 through a via conductor 151 penetrating the substrate 20. Further, out of the turns of the first coil 110, the second turn counted from the outermost turn (second turn counted from the innermost turn) is partially discontinuous. One end and the other end of the discontinuous part are connected respectively to via conductors 152 and 153 penetrating the substrate 20. The via conductor 152 is connected to one end of the connection pattern 141, and the via conductor 153 is connected to one end of the connection pattern 142. The other ends of the connection patterns 141 and 142 are connected respectively to via conductors 154 and 155 penetrating the substrate 20. The via conductors 154 and 155 are connected respectively to the inner and outer peripheral ends of the second coil 120.

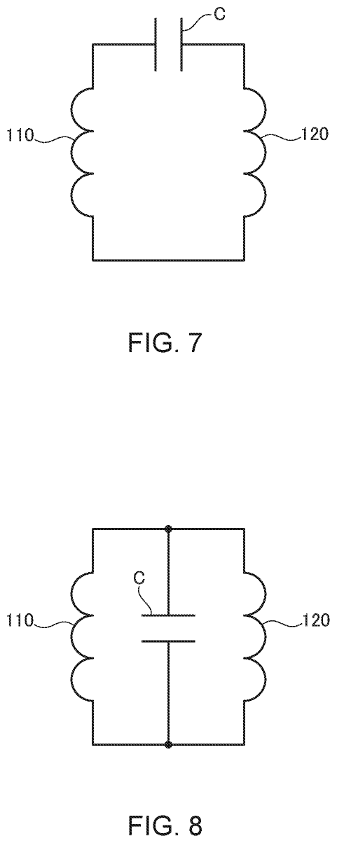

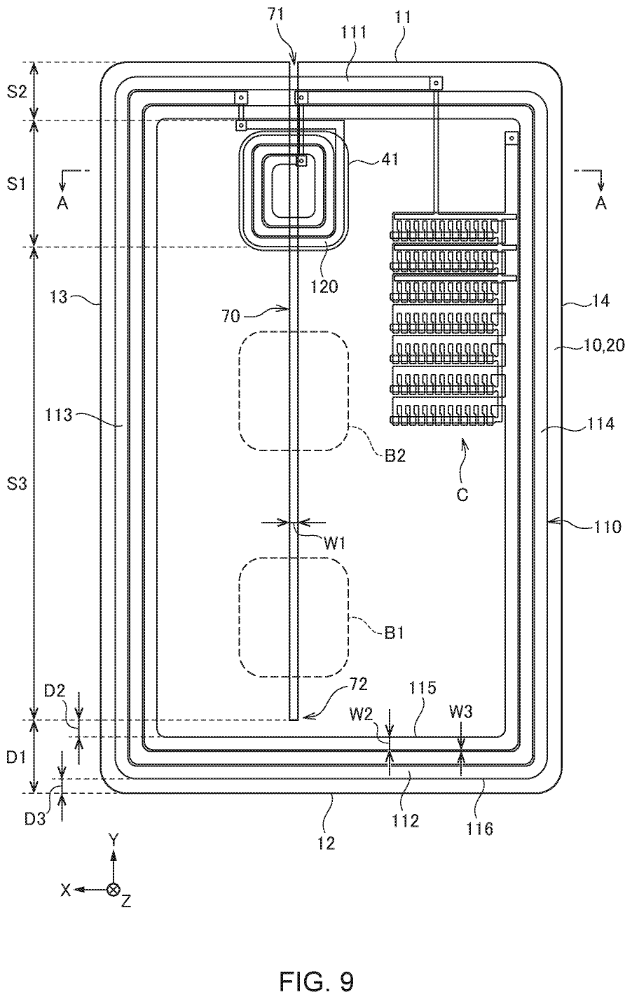

With the above configuration, the first coil 110 and second coil 120 are connected in series to each other and, as illustrated in FIG. 7, the capacitor C is connected in series to the first and second coils 110 and 120. A resonance circuit constituted by the first and second coils 110, 120 and capacitor C forms a closed circuit not connected to any external circuits. The capacitor C acts to enhance communication characteristics through adjustment of the resonance frequency. By setting the resonance frequency of the closed circuit to a frequency band around 13.56 MHZ or 13.56 MHZ, NFC (Near Field Communication) is enabled. Alternatively, as illustrated in FIG. 8, the capacitor C may be connected in parallel to the first and second coils 110 and 120. In this case, designing the line length of the first coil 110 smaller than the line length of the second coil 120 allows achievement of the same resonance characteristics as those obtained when the capacitor C is connected in series to the first and second coils 110 and 120.

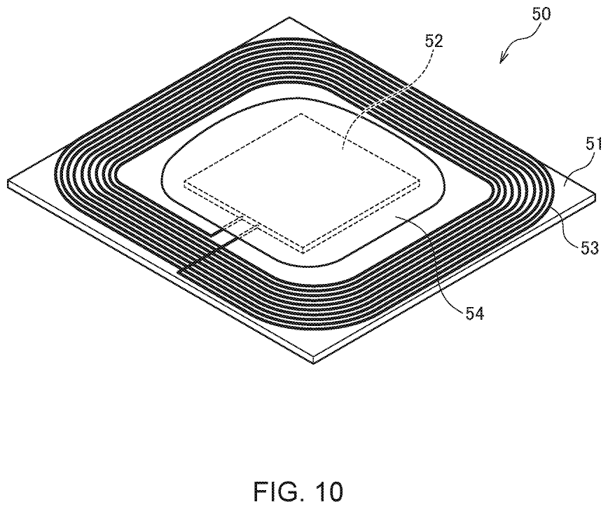

FIG. 9 is a schematic plan view illustrating a state where the bottom metal plate 10 and substrate 20 overlap each other.

As illustrated in FIG. 9, the bottom metal plate 10 and substrate 20 are made to overlap each other such that the second coil 120 is disposed at an area surrounded by the through hole 41 in a plan view (as viewed in the Z-direction). In this state, the first coil 110 travels around along the outer edges 11 to 14 of the bottom metal plate 10 in an overlapping state with the bottom metal plate 10 in a plan view (as viewed in the Z-direction). The section 111 of the first coil 110 that extends in the X-direction along the outer edge 11 partially overlaps the slit 70. On the other hand, the section 112 of the first coil 110 that extends in the X-direction along the outer edge 12 does not overlap the slit 70. That is, the second end 72 of the slit 70 is positioned inside the innermost turn of the first coil 110.

The second end 72 of the slit 70 is away from an inner edge 115 of the innermost turn of the first coil 110 by a second distance D2. The second distance D2 may be larger than a pattern width W2 of the first coil 110. An outer edge 116 of the outermost turn of the first coil 110 is away from the outer edge 12 of the bottom metal plate 10 by a third distance D3. The second distance D2 may be larger than the third distance D3. This is because, since a magnetic flux density becomes maximum in the vicinity of the innermost turn of the first coil 110 in the opening 110a, ensuring the second distance D2 to a certain extent allows more magnetic flux to be applied to the bottom metal plate 10 functioning as an antenna.

As illustrated in FIG. 9, the second coil 120 is disposed at a position crossed by the slit 70. Thus, the slit 70 is sectioned into a first section S1 overlapping the second coil 120, a second section S2 positioned between the first section S1 and the first end 71, and a third section S3 positioned between the first section S1 and the second end 72. The first section S1 is a section between a part of the second coil 120 that overlaps the outer edge of the outermost turn on one side in the Y-direction and a part of the second coil 120 that overlaps the outer edge of the outermost turn on the other side in the Y-direction. In the present embodiment, the second coil 120 is disposed offset to the one side in the Y-direction, and thus the third section S3 is longer than the second section S2. The length of the third section S3 is sufficiently large and is larger than at least the first distance D1. As described above, the first distance D1 is the distance between the second end 72 of the slit 70 and the outer edge 12 of the bottom metal plate 10 in the Y-direction.

The second coil 120 may be disposed offset to the other side in the Y-direction. For example, the second coil 120 may be disposed at a position B1 illustrated in FIG. 9. In this case, the third section S3 is shorter than the second section S2. In such a case, the length of the second section S2 is made larger than the first distance D1. Alternatively, the second coil 120 may be disposed at the intermediate position of the slit 70 in the Y-direction. For example, the second coil 120 may be disposed at a position B2 illustrated in FIG. 9. In this case, the lengths of the second and third sections S2 and S3 are the same as each other. In such a case, the lengths of the second and third sections S2 and S3 are made larger than the first distance D1. That is, the first distance D1 may be designed smaller than the longer one of the second and third sections S2 and S3. However, making the third section S3 longer than the second section S2 can increase communication distance.

The width W1 of the slit 70 in the X-direction may be larger than a width W3 of a space between adjacent turns of the first coil 110. This can enhance the radiation characteristics of the bottom metal plate 10 while ensuring a sufficient area of the opening 110a of the first coil 110.

FIG. 10 is a schematic perspective view of the IC module 50 as viewed from the back surface side thereof.

As illustrated in FIG. 10, the IC module 50 includes a module substrate 51, an IC chip 52 mounted on or incorporated in the module substrate 51, and a coupling coil 53. The IC chip 52 is protected by being covered with a dome-shaped protective resin 54. The protective resin 54 is made of an insulating member and may be partially disposed in the through hole 31, as illustrated in FIG. 3. The terminal electrode E illustrated in FIG. 1 is provided on the back surface side of the module substrate 51. The IC module 50 thus configured is accommodated in the through hole 41 formed in the top metal plate 40. In a state where the IC module 50 is accommodated in the through hole 41, the coupling coil 53 and second coil 120 provided on the substrate 20 are electromagnetically coupled to each other. The second coil 120 is connected in series to the first coil 110 as described above, so that when a current flows in the second coil 120, it also flows in the first coil 110 to generate a magnetic field from the first coil 110. The magnetic field generated from the first coil 110 causes an eddy current in the bottom metal plate 10. The eddy current generated in the bottom metal plate 10 includes, as illustrated in FIG. 4, a component P traveling around along the outer periphery of the bottom metal plate 10 and a component Q traveling around along the slit 70. The components P and Q travel around in the opposite directions. The component Q traveling around in the clockwise direction contributes to communication, and the component P traveling around in the counterclockwise direction cancels the magnetic flux of an antenna. The component Q traveling around along the slit 70 is thus generated in the bottom metal plate 10, allowing the bottom metal plate 10 itself to function as an antenna.

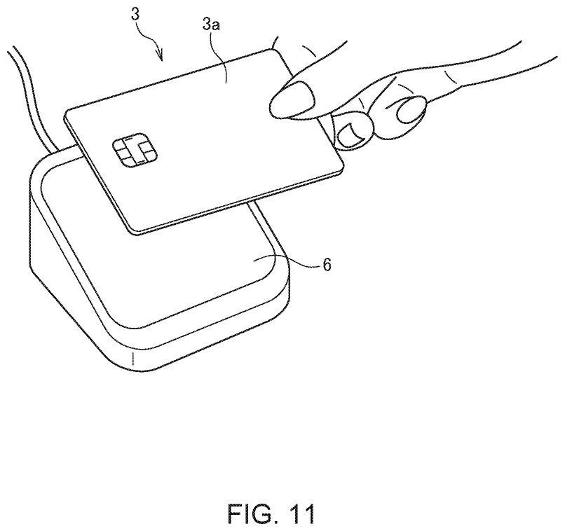

Thus, as illustrated in FIG. 11, when the back surface 3b of the IC card 3 is made to face a card reader 6, communication can be performed between the card reader 6 and the IC chip 52. That is, the card reader 6 is coupled to the coupling coil 53 of the IC module 50 through the antenna device 1 constituted by the bottom metal plate 10 and first and second coils 110 and 120 and can thereby communicate with the IC chip 52.

As described above, the IC card 3 according to the present embodiment includes the antenna device 1 constituted by the first and second coils 110 and 120 and the bottom metal plate 10 having the slit 70, so that, despite the fact that both the upper and back surfaces 3a and 3b are made of a metal material, communication can be achieved by making the back surface 3b of the IC card 3 face the card reader 6. In addition, the slit 70 has a sufficient length, thus allowing an eddy current to largely travel around along the outer edges 11 to 14 of the bottom metal plate 10, which can increase communication distance. Further, since the first coil 110 is wound along the outer edges 11 to 14, communication distance can be further increased.

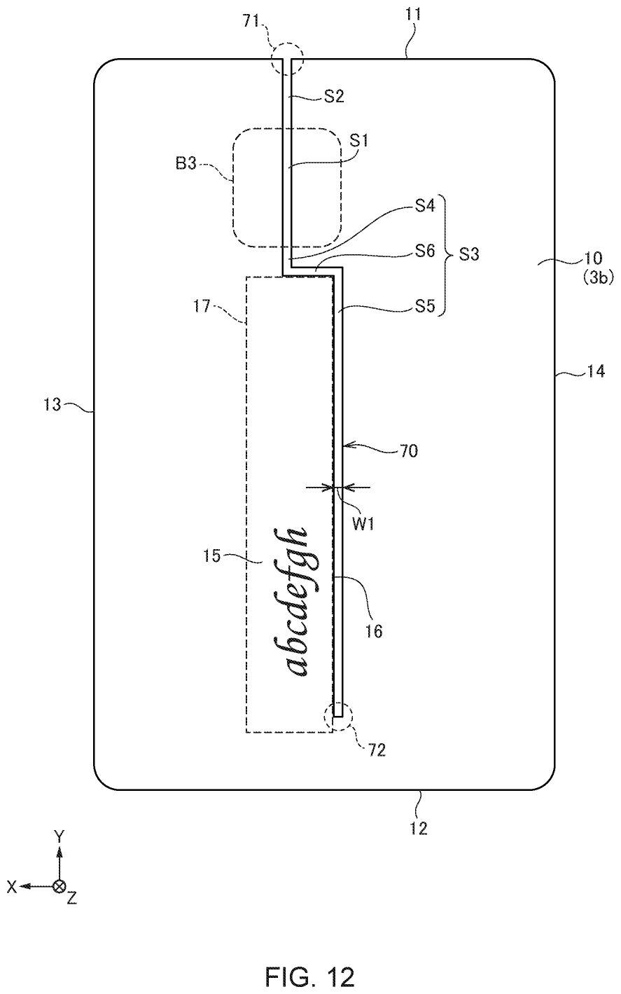

FIG. 12 is a schematic plan view of the bottom metal plate 10 according to a modification.

The bottom metal plate 10 illustrated in FIG. 12 differs from the bottom metal plate 10 illustrated in FIG. 4 in that the third section S3 of the slit 70 includes fourth to sixth sections S4 to S6. Other basic configurations are the same as those of the bottom metal plate 10 illustrated in FIG. 4, so the same reference numerals are given to the same elements, and overlapping description will be omitted. The second coil 120 is disposed at a position B3 illustrated in FIG. 12.

The fourth section S4 extends in the Y-direction, and one end thereof is connected to the first section S1. The fifth section S5 extends in the Y-direction, and one end thereof constitutes the second end 72. The X-direction positions of the fourth and sixth sections S4 and S5 differ from each other. The sixth section S6 extends in the X-direction and connects the other ends of the fourth and fifth sections S4 and S5. As described above, the slit 70 formed in the bottom metal plate 10 need not be linear in the Y-direction but may be bent in a crank shape, as illustrated. Further, the extending direction of the sixth section S6 need not completely coincide with the X-direction but may have a predetermined inclination with respect to the X-direction.

In the example illustrated in FIG. 12, a signature field 15 is provided on the surface of the bottom metal plate 10 that constitutes the back surface 3b of the IC card 3. A signature of a user of the IC card 3 is written in the signature field 15. The slit 70 is bent in a crank shape so as not to overlap the signature field 15. The signature field 15 has a first edge 16 extending in the Y-direction and a second edge 17 extending along the X-direction. The fifth section S5 extends along the first edge 16 of the signature field 15, and the sixth section S6 extends along the second edge 17 of the signature field 15. In the example illustrated in FIG. 12, the signature field 15 and second coil 120 overlap each other in the X-direction. In this case, if the third section S3 of the slit 70 extends linearly in the Y-direction from the first section S1, the signature field 15 and slit 70 overlap each other. To cope with this, the third section S3 of the slit 70 is bent in a crank shape along the first and second edges 16 and 17 of the signature field 15, thus preventing overlap between the slit 70 and the signature field 15.

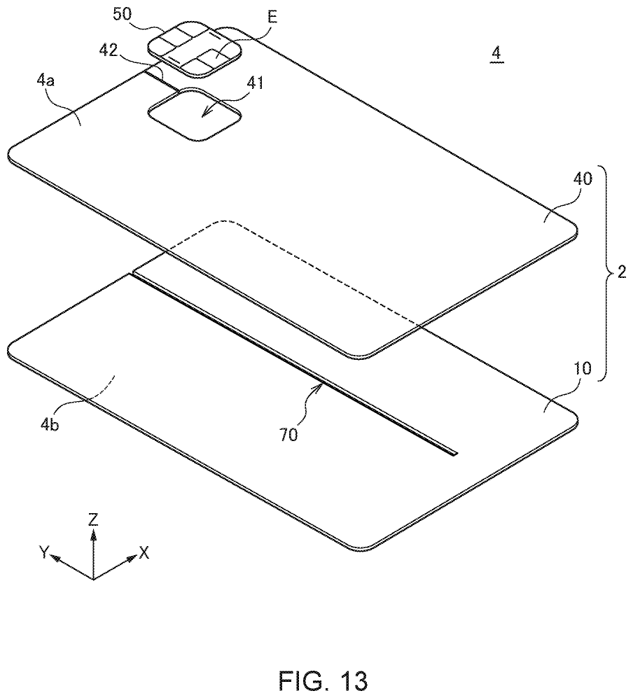

FIG. 13 is a schematic exploded perspective view for explaining the structure of an IC card 4 having an antenna device 2 according to a second embodiment of the present disclosure.

The IC card 4 illustrated in FIG. 13 has a structure in which the bottom metal plate 10 and top metal plate 40 are laminated in this order from the back surface 4b side to the upper surface 4a side. That is, unlike the above-described IC card 3, neither the substrate 20 nor magnetic body 30 is provided between the bottom metal plate 10 and the top metal plate 40. Instead, a slit 42 is formed in the top metal plate 40. The antenna device 2 according to the present embodiment is constituted by the thus configured bottom and top metal plates 10 and 40. The bottom and top metal plates 10 and 40 are stuck to each other through a not-shown insulating adhesive. As a result, the bottom and top metal plates 10 and 40 are insulated from each other. Other basic configurations are the same as those of the above-described IC card 3, so the same reference numerals are given to the same elements, and overlapping description will be omitted.

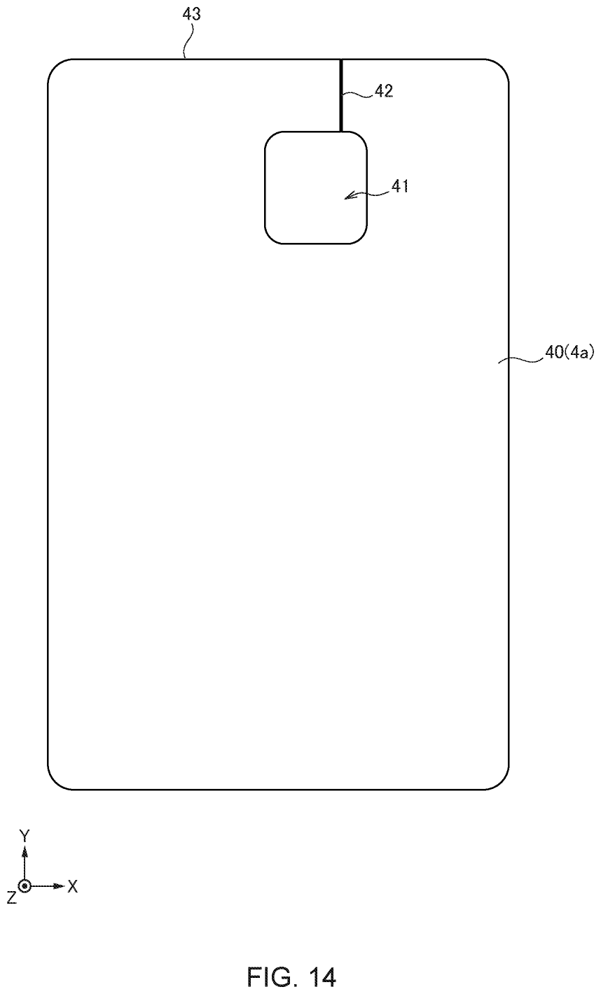

FIG. 14 is a schematic plan view of the bottom metal plate 10 used for the antenna device 2.

As illustrated in FIG. 14, the slit 42 formed in the top metal plate 40 connects an outer edge 43 of the top metal plate 40 that extends in the X-direction and the through hole 41. The width of the slit 42 as a second slit is smaller than the width of the slit 70 as a first slit, whereby the beauty of appearance on the upper surface 4a side of the IC card 4 is maintained. The IC module 50 is disposed in the through hole 41. As described above, the IC module 50 includes the coupling coil 53, and a magnetic field generated from the coupling coil 53 causes an eddy current in the bottom metal plate 10. Since the slit 70 is formed in the bottom metal plate 10, the bottom metal plate 10 itself functions as an antenna. Although neither the coil pattern nor magnetic body is provided between the bottom and top metal plates 10 and 40 in the present embodiment, the presence of the slit 42 in the top metal plate 40 prevents communication from being hindered by the top metal plate 40.

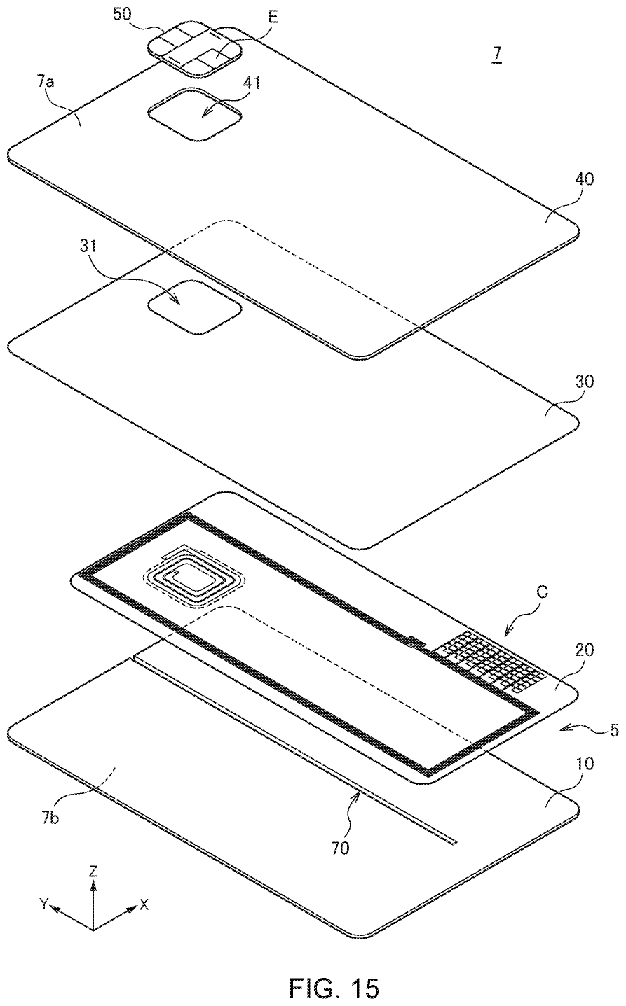

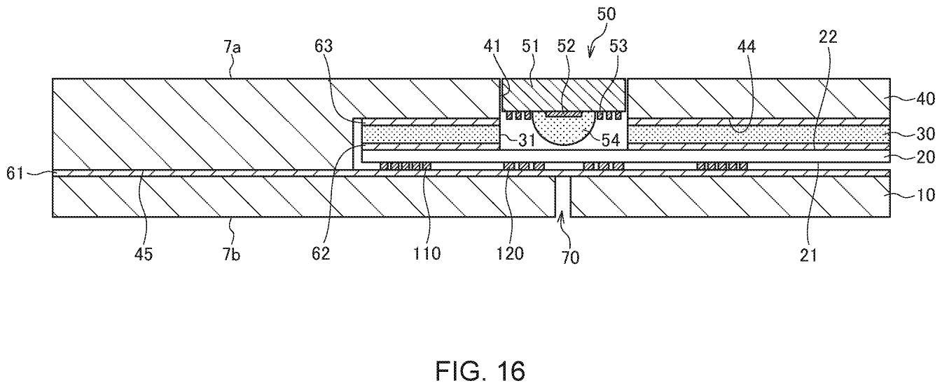

FIGS. 15 and 16 are respectively a schematic exploded perspective view and a schematic cross-sectional view for explaining the structure of an IC card 7 having an antenna device 5 according to a third embodiment of the present disclosure.

The IC card 7 illustrated in FIGS. 15 and 16 has a structure in which the bottom metal plate 10, substrate 20, magnetic body 30, and top metal body 40 are laminated in this order from a back surface 7b side to an upper surface 7a side. The bottom metal plate 10 constitutes a first metal plate, and the surface thereof constitutes the back surface 7b of the IC card 7. The top metal plate 40 constitutes a second metal plate, and the surface thereof constitutes the upper surface 7a of the IC card 7. The top metal plate 40 and bottom metal plate 10 are each made of a metal material such as stainless steel or titanium. The top metal plate 40 has the through hole 41 in which the IC module 50 is disposed. Thus, the IC card 7 is a card whose upper and back surfaces are constituted by the metal plates. Further, as illustrated in FIG. 16, the top metal plate 40 has a concave part 44 and a convex part 45. The thickness of the top metal plate 40 is smaller in the concave part 44 than in the convex part 45. The through hole 41 is formed in the concave part 44. The substrate 20 and magnetic body 30 are disposed so as to be sandwiched between the bottom metal plate 10 and the concave part 44 of the top metal plate 40.

The width of the substrate 20 in the X-direction is smaller than the widths of the bottom and top metal plates 10 and 40 in the X-direction, and the substrate 20 is disposed at a position overlapping the concave part 44 of the top metal plate 40. Thus, as illustrated in FIG. 16, the bottom metal plate 10 and convex part 45 of the top metal plate 40 directly face each other, not through the substrate 20 and magnetic body 30. The bottom metal plate 10 and the convex part 45 of the top metal plate 40 are stuck to each other through the adhesive layer 61. The magnetic body 30 is stuck to the concave part 44 of the top metal plate 40 through the adhesive layer 63. The structure of the bottom metal plate 10 is as illustrated in FIG. 4.

The substrate 20 and magnetic body 30 can be produced in multiple numbers. Specifically, conductor patterns are formed on both surfaces of a large-area insulating film, and then the magnetic body 30 is stuck to the surface of the resultant insulating film to form an aggregated sheet, followed by cutting of the aggregated sheet. In the present embodiment, since the widths of the substrate 20 and magnetic body 30 in the X-direction are reduced, larger numbers of the substrates 20 and magnetic bodies 30 can be taken from one aggregate sheet, thereby reducing manufacturing cost. Further, the substrate 20 and magnetic body 30 are provided at a position overlapping the concave part 44 of the top metal plate 40, allowing a reduction in level difference between an area where the substrate 20 and magnetic body 30 are present and an area where they are absent.

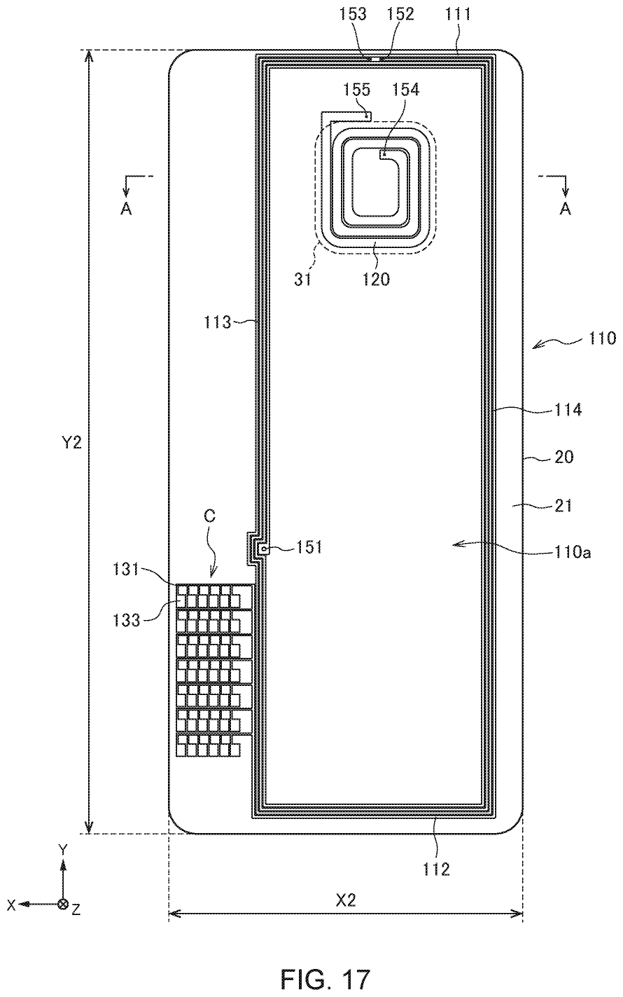

FIG. 17 is a schematic plan view of the conductor patterns formed on the first main surface 21 of the substrate 20.

As illustrated in FIG. 17, the first main surface 21 of the substrate 20 has thereon the first coil 110, second coil 120, and capacitor patterns 131 and 133. The first coil 110 is a pattern wound in about four turns. The second coil 120 is disposed inside the opening 110a of the first coil 110, and the capacitor patterns 131 and 133 are disposed outside the first coil 110. The first coil 110 has the sections 111 and 112 extending in the X-direction along the respective outer edges 11 and 12 of the bottom metal plate 10 and the sections 113 and 114 extending in the Y-direction along the slit 70. The first coil 110 has a size larger in the Y-direction than in the X-direction.

The second coil 120 is disposed at a position overlapping the through hole 31 of the magnetic body 30. In the example illustrated in FIG. 17, the number of turns of the second coil 120 is about three. In the present embodiment, since the capacitor patterns 131 and 133 are disposed outside the first coil 110, magnetic flux generated from the first coil 110 is unlikely to be applied to the capacitor patterns 131 and 133, so that the characteristics of the first coil 110 hardy change in the presence of the capacitor patterns 131 and 133. Further, the capacitor patterns 131 and 133 are disposed on the X-direction side as viewed from the first coil 110, so that the width of the first coil 110 in the Y-direction can be sufficiently ensured.

The capacitor pattern 131 is a pattern branched from the outermost turn of the first coil 110. In the example illustrated in FIG. 17, seven capacitor patterns 131 are branched from the outermost turn of the first coil 110; however, the number of the capacitor patterns 131 is not particularly limited. Further, a plurality of the capacitor patterns 133 are branched from one capacitor pattern 131. The capacitor patterns 133 all extend in the Y-direction. In the example illustrated in FIG. 17, six capacitor patterns 133 are branched from the capacitor pattern 131; however, the number of the capacitor patterns 133 is not particularly limited.

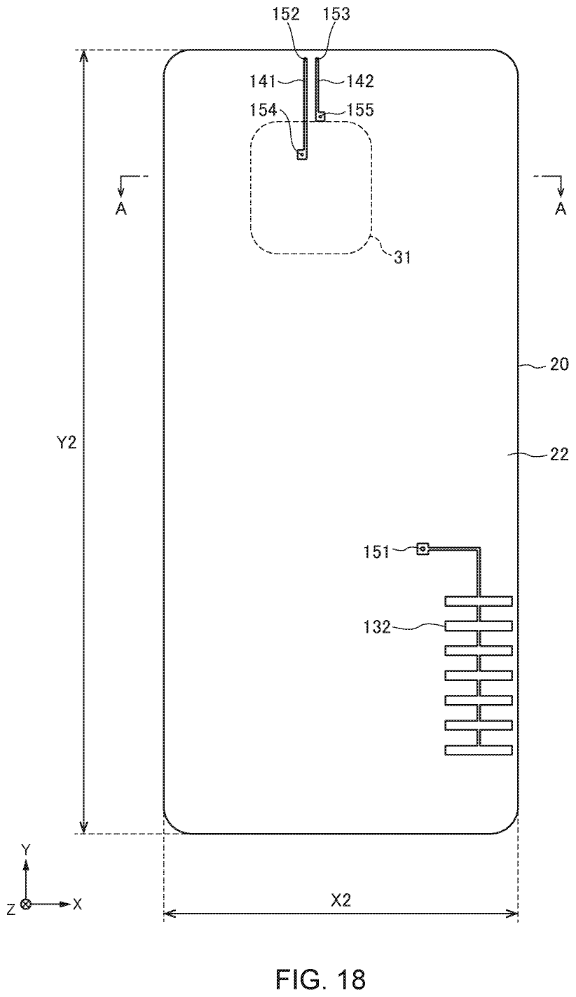

FIG. 18 is a schematic plan view of the conductor patterns formed on the second main surface 22 of the substrate 20.

As illustrated in FIG. 18, the second main surface 22 of the substrate 20 has thereon the capacitor patterns 132 and the connection patterns 141 and 142. The planar position of the capacitor pattern 132 coincides with that of the capacitor pattern 133. That is, the capacitor patterns 131 and 133 are opposed to each other through the substrate 20. Thus, the capacitor pattern 133 provided on the first main surface 21 of the substrate 20, the capacitor pattern 132 provided on the second main surface 22 of the substrate 20, and the substrate 20 positioned therebetween constitute the capacitor C. The capacitance of the capacitor C having such a pattern shape can be finely adjusted by removing some of the capacitor patterns 133 by trimming.

As illustrated in FIGS. 17 and 18, the inner peripheral end of the first coil 110 is connected to the capacitor pattern 132 through the via conductor 151 penetrating the substrate 20. Further, out of the turns of the first coil 110, the second turn counted from the outermost turn (third turn counted from the innermost turn) is partially discontinuous. One end and the other end of the discontinuous part are connected respectively to the via conductors 152 and 153 penetrating the substrate 20.

The via conductor 152 is connected to one end of the connection pattern 141, and the via conductor 153 is connected to one end of the connection pattern 142. The other ends of the connection patterns 141 and 142 are connected respectively to the via conductors 154 and 155 penetrating the substrate 20. The via conductors 154 and 155 are connected respectively to the inner and outer peripheral ends of the second coil 120.

With the above configuration, the first coil 110 and second coil 120 are connected in series to each other and, as illustrated in FIG. 7, the capacitor C is connected in series to the first and second coils 110 and 120.

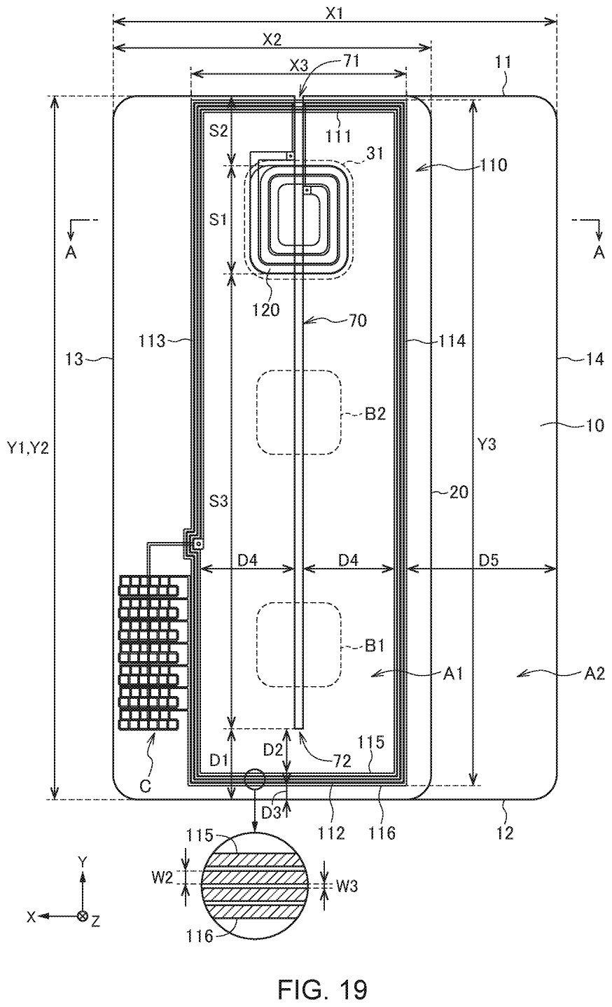

FIG. 19 is a schematic plan view illustrating a state where the bottom metal plate 10 and substrate 20 overlap each other.

As illustrated in FIG. 19, the bottom metal plate 10 and substrate 20 are made to overlap each other such that the second coil 120 is disposed at an area surrounded by the through hole 41 in a plan view (as viewed in the Z-direction). A length Y2 of the substrate 20 in the Y-direction may be substantially the same as the length Y1 of the bottom metal plate 10 in the Y-direction, while a length X2 of the substrate 20 in the X-direction is smaller than a length X2 of the bottom metal plate 10 in the X-direction, whereby
X2/X1<Y2/Y1 is satisfied. That is, the substrate 20 has a more elongate shape than the bottom metal plate 10. As a result, the bottom metal plate 10 includes a part that does not overlap the substrate 20.

Further, when the bottom metal plate 10 and the substrate 20 are made to overlap each other, the first coil 110 travels around along the slit 70 in an overlapping state with the bottom metal plate 10 in a plan view (as viewed in the Z-direction). The section 111 of the first coil 110 that extends in the X-direction along the outer edge 11 partially overlaps the slit 70. On the other hand, the section 112 of the first coil 110 that extends in the X-direction along the outer edge 12 does not overlap the slit 70. That is, the second end 72 of the slit 70 is positioned inside the innermost turn of the first coil 110.

When the width (length of the sections 111 and 112 in the X-direction) of the first coil 110 in the X-direction is X3, and the width (length of the sections 113 and 114 in the Y-direction) of the first coil 110 in the Y-direction is Y3,
X3/X2<Y3/Y2 is satisfied. That is, the first coil 110 has a more elongate shape than the substrate 20. When a part of the surface of the bottom metal plate 10 that overlaps the opening 110a of the first coil 110 is defined as an inside area A1, and a part thereof that does not overlap the opening 110a of the first coil 110 is defined as an outside area A2, the inside area A1 is smaller than the outside area A2. When no difference exists between the length Y1 of the bottom metal plate 10 in the Y-direction and the width Y3 of the first coil 110 in the Y-direction, the width X3 of the first coil 110 in the X-direction may be made less than half of the length X1 of the bottom metal plate 10 in the X-direction to satisfy A1<A2.

Further, a fourth distance D4 in the X-direction between the inner edge 115 of the innermost turn of the first coil 110 and the slit 70 may be smaller than a fifth distance D5 in the X-direction between the outer edge 116 of the outermost turn of the first coil 110 and the outer edge 14 of the bottom metal plate 10. This makes the shape of the first coil 110 still more elongate. When the fourth distance D4 differs depending on the Y-direction position, the maximum value thereof may be defined as the fourth distance D4. Similarly, when the fifth distance D5 differs depending on the Y-direction position, the maximum value thereof may be defined as the fifth distance D5. In the present embodiment, the fourth distance D4 in the X-direction between the inner edge 115 of the innermost turn of the first coil 110 and the slit 70 is smaller than the fifth distance D5 in the X-direction between the outer edge 116 of the outermost turn of the first coil 110 and the outer edge 14 of the bottom metal plate 10. The fourth distance D4 in the X-direction between the inner edge 115 of the innermost turn of the first coil 110 and the slit 70 may be larger than a distance between the outer edge 116 of the outermost turn of the first coil 110 and the outer edge 13 of the bottom metal plate 10.

Further, the first coil 110 is not positioned at the center in the X-direction but offset to the outer edge 13 side of the bottom metal plate 10. Thus, the fourth distance D4 on one side in the X-direction of the slit 70 and the fourth distance D4 on the other side in the X-direction of the slit 70 are substantially the same as each other, and the slit 70 overlaps the axial center of the first coil 110.

The second end 72 of the slit 70 is away from the inner edge 115 of the innermost turn of the first coil 110 by the second distance D2. The second distance D2 may be larger than the pattern width W2 of the first coil 110. The outer edge 116 of the outermost turn of the first coil 110 is away from the outer edge 12 of the bottom metal plate 10 by the third distance D3. The second distance D2 may be larger than the third distance D3. This is because, since a magnetic flux density becomes maximum in the vicinity of the innermost turn of the first coil 110 in the opening 110a, ensuring the second distance D2 to a certain extent allows more magnetic flux to be applied to the bottom metal plate 10 functioning as an antenna.

As illustrated in FIG. 19, the second coil 120 is disposed at a position crossed by the slit 70. Thus, the slit 70 is sectioned into the first section S1 overlapping the second coil 120, the second section S2 positioned between the first section S1 and the first end 71, and the third section S3 positioned between the first section S1 and the second end 72. The first section S1 is a section between a part of the second coil 120 that overlaps the outer edge of the outermost turn on one side in the Y-direction and a part of the second coil 120 that overlaps the outer edge of the outermost turn on the other side in the Y-direction. In the present embodiment, the second coil 120 is disposed offset to the one side in the Y-direction, and thus the third section S3 is longer than the second section S2. The length of the third section S3 is sufficiently large and is larger than at least the first distance D1. As described above, the first distance D1 is the distance between the second end 72 of the slit 70 and the outer edge 12 of the bottom metal plate 10 in the Y-direction.

The second coil 120 may be disposed offset to the other side in the Y-direction. For example, the second coil 120 may be disposed at a position B1 illustrated in FIG. 19. In this case, the third section S3 is shorter than the second section S2. In such a case, the length of the second section S2 is made larger than the first distance D1. Alternatively, the second coil 120 may be disposed at the intermediate position of the slit 70 in the Y-direction. For example, the second coil 120 may be disposed at a position B2 illustrated in FIG. 19. In this case, the lengths of the second and third sections S2 and S3 are the same as each other. In such a case, the lengths of the second and third sections S2 and S3 are made larger than the first distance D1. That is, the first distance D1 may be designed smaller than the longer one of the second and third sections S2 and S3. However, making the third section S3 longer than the second section S2 can further increase communication distance.

The width W1 of the slit 70 in the X-direction may be larger than the width W3 of a space between adjacent turns of the first coil 110. This can enhance the radiation characteristics of the bottom metal plate 10 while ensuring a sufficient area of the opening 110a of the first coil 110.

As described above, the IC card 7 according to the present embodiment includes the antenna device 5 constituted by the first and second coils 110 and 120 and the bottom metal plate 10 having the slit 70, so that, despite the fact that both the upper and back surfaces 7a and 7b are made of a metal material, communication can be achieved by making the back surface 7b of the IC card 7 face the card reader 6. In addition, the slit 70 has a sufficient length, thus allowing an eddy current to largely travel around along the outer edges 11 to 14 of the bottom metal plate 10, which can increase communication distance. Further, since the length X2 of the substrate 20 in the X-direction is smaller than the length X1 of the bottom metal plate 10 in the X-direction, manufacturing cost can be reduced when multiple substrates 20 are manufactured at a time.

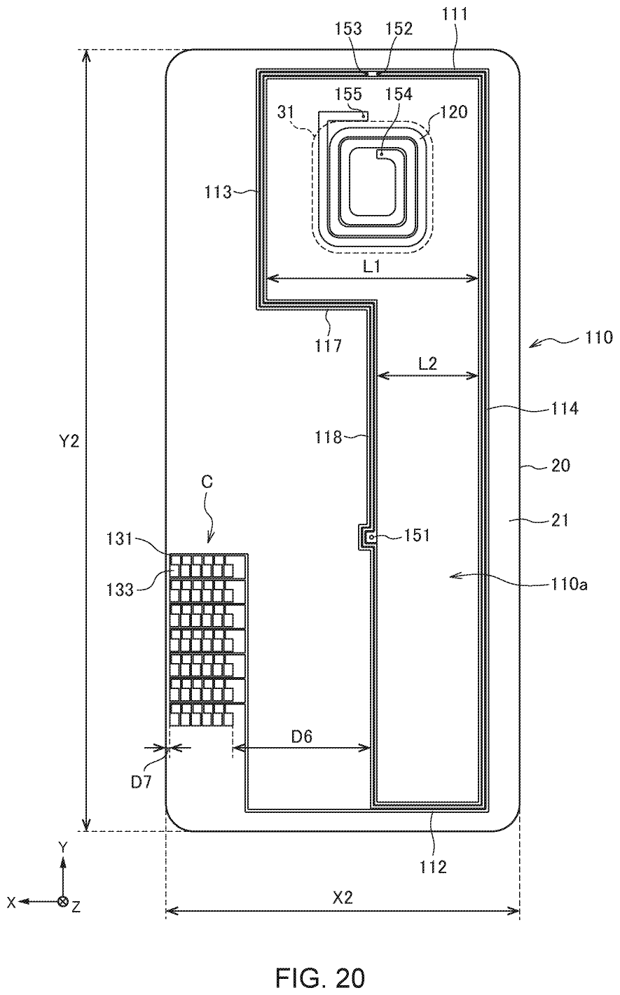

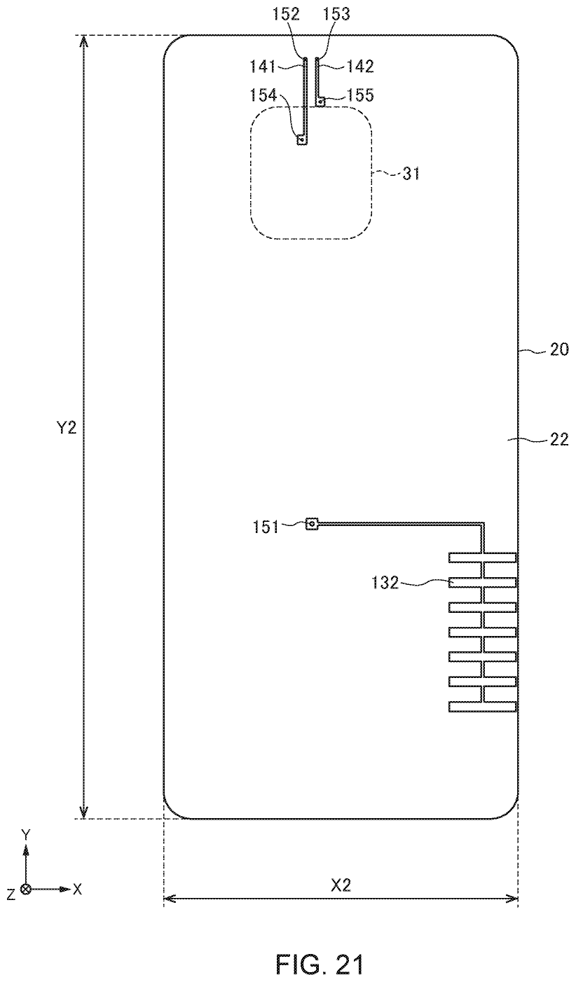

FIGS. 20 and 21 are schematic plan views of the conductor patterns formed on the first main surface 21 (FIG. 20) and second main surface 22 (FIG. 21) of the substrate 20 when the bottom metal plate 10 according to a modification is used.

As illustrated in FIG. 20, when the bottom metal plate 10 according to the modification is used, the lengths of the sections 112 and 113 of the first coil 110 are reduced, and sections 117 and 118 are newly provided between the sections 112 and 113. The section 117 extends in the X-direction, and one end thereof is connected to the section 113. The section 118 extends in the Y-direction, and one end thereof is connected to the section 112. The other ends of the sections 117 and 118 are connected to each other. With this configuration, the width of the opening 110a of the first coil 110 in the X-direction is a first width L1 at a portion between the sections 113 and 114 and is a second width L2 smaller than the first width L1 at a portion between the sections 114 and 118. When the first width L1 differs depending on the Y-direction position, the maximum value thereof may be defined as the first width L1. Similarly, when the second width L2 differs depending on the Y-direction position, the maximum value thereof may be defined as the second width L2.

In the example illustrated in FIG. 20 as well, the positions of the capacitor patterns 131 and 133 are the same as those illustrated in FIG. 17. That is, the capacitor patterns 131 and 133 are disposed on the X-direction side as viewed from the section 118 of the first coil 110. The capacitor patterns 131 and 133 are away in the X-direction from the outer edge of the outermost turn of the section 118 of the first coil 110 by a sixth distance D6 and away in the X-direction from the outer edge of the bottom metal plate 10 by a seventh distance D7. The sixth distance D6 is larger than the seventh distance D7. Thus, as compared with the example illustrated in FIG. 17, the distance in the X-direction between the capacitor patterns 131, 133 and the first coil 110 increases by the length of the section 117, reducing influence that the capacitor patterns 131 and 133 have on the characteristics of the first coil 110. Further, although not illustrated, when the capacitor patterns 131 and 133 are brought closer to the section 118 of the first coil 110, the length of the substrate 20 in the X-direction can be further reduced.

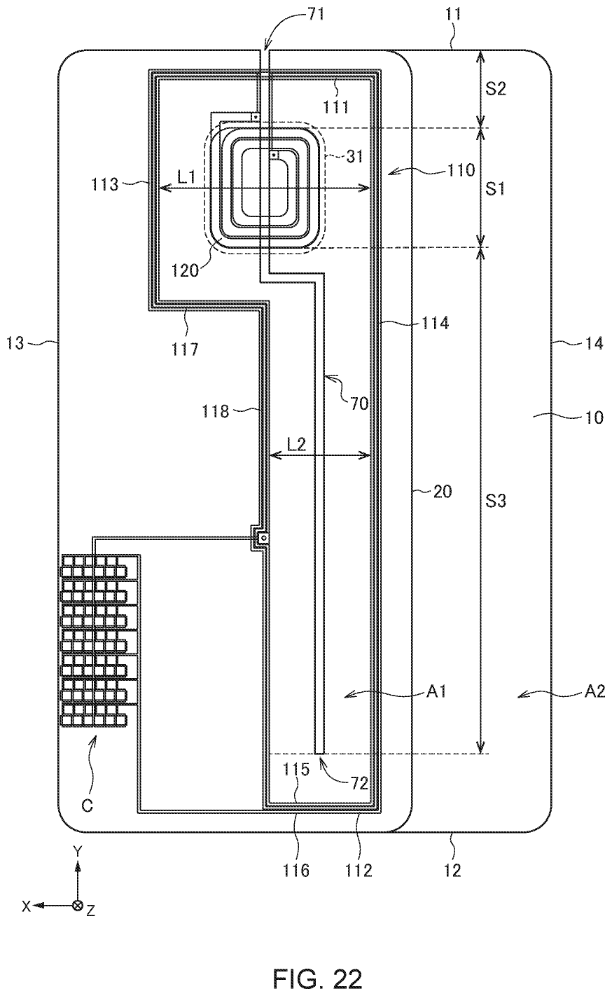

FIG. 22 is a schematic plan view illustrating a state where the bottom metal plate 10 illustrated in FIG. 12 and the substrate 20 illustrated in FIGS. 20 and 21 overlap each other.

As illustrated in FIG. 22, when the bottom metal plate 10 illustrated in FIG. 12 and the substrate 20 illustrated in FIGS. 20 and 21 are made to overlap each other, the first section S1, at least a part of the second section S2, fourth section S4, and sixth section S6 of the slit 70 are disposed in a part of the opening 110a of the first coil 110 that has the first width L1, and the fifth section S5 of the slit 70 is disposed in a part of the opening 110a of the first coil 110 that has the second width L2. Accordingly, the part of the opening 110a of the first coil 110 that has the first width L1 crosses in the X-direction the first section S1, at least a part of the second section S2, and fourth section S4 of the slit 70, and the part of the opening 110a of the first coil 110 that has the second width L2 crosses in the X-direction the fifth section S5 of the slit 70. The first section S1, second section S2, fourth section S4, and fifth section S5 of the slit 70 all overlap the axial center of the first coil 110.

When the slit 70 is thus bent in a crank shape, the width of the opening 110a of the first coil 110 is set to the first width L1 at the part of the opening 110a that crosses in the X-direction the first section S1 of the slit 70 and set to the second width L2, which is smaller than the first width L1, at the part of the opening 110a that crosses in the X-direction the fifth section S5 of the slit 70. This allows the crank-shaped slit 70 to be disposed at the axial center of the first coil 110 without increasing the length of the substrate 20 in the X-direction.

While the preferred embodiment of the present disclosure has been described, the present disclosure is not limited to the above embodiment, and various modifications may be made within the scope of the present disclosure, and all such modifications are included in the present disclosure.

For example, the conductor patterns provided on the first and second main surfaces 21 and 22 of the substrate 20 may be provided thereon through another material layer such as a conductive resin layer.

The technology according to the present disclosure includes the following configuration examples but not limited thereto.

An antenna device according to one embodiment of the present disclosure includes: a first metal plate; a first coil disposed so as to overlap the first metal plate in a plan view and wound along the outer edge of the first metal plate; and a second coil disposed inside the opening of the first coil and connected to the first coil. The first metal plate has a slit extending in the longer length direction of the first metal plate. The slit has first and second ends positioned at its both ends in the longer length direction. The first end is opened so as to divide the outer edge of the first metal plate, and the second end does not reach the outer edge of the first metal plate and is terminated at a position away from the outer edge by a first distance. The slit includes a first section overlapping the second coil, a second section positioned between the first section and the first end, and a third section positioned between the first section and the second end. The first distance is smaller than the longer one of the second and third sections. With the above configuration, communication distance can be increased.

In the above antenna device, the third section may be larger in length than the second section. This can further increase communication distance.

In any of the above antenna devices, the width of the slit may be constant. This can maintain the beauty of appearance when the first metal plate is used as a bottom metal plate for an IC card.

In any of the above antenna devices, the second end of the slit may be positioned inside the innermost turn of the first coil. This can further increase communication distance.

In the above antenna device, the second end of the slit may be away from the inner edge of the innermost turn of the first coil by a second distance, the outer edge of the outermost turn of the first coil may be away from the outer edge of the first metal plate by a third distance, and the second distance may be larger than the third distance. This can apply more magnetic flux to the first metal plate functioning as an antenna.

In the above antenna device, the second distance may be larger than the pattern width of the first coil. This can apply more magnetic flux to the first metal plate functioning as an antenna.

In any of the above antenna devices, the width of the slit may be larger than the width of a space between adjacent turns of the first coil and smaller than the pattern width of the first coil. This can enhance the radiation characteristics of the first metal plate while ensuring a sufficient opening area of the first coil.

Any of the above antenna devices may further include a capacitor connected in series to the first and second coils. Alternatively, any of the above antenna devices may further include a capacitor connected in parallel to the first and second coils, and the line length of the first coil may be smaller than that of the second coil. In either case, a resonance frequency can be adjusted by the capacitance of the capacitor. Further, a current more easily flows in the first coil to thereby further increase communication distance.

An antenna device according to another embodiment of the present disclosure includes: a first metal plate; a first coil disposed so as to overlap the first metal plate in a plan view; and a second coil disposed inside the opening of the first coil and connected to the first coil. The first metal plate has a slit extending in the longer length direction of the first metal plate. The slit has first and second ends positioned at its both ends in the longer length direction. The first end is opened so as to divide the outer edge of the first metal plate, and the second end does not reach the outer edge of the first metal plate and is terminated at a position away from the outer edge by a first distance. The slit includes a first section overlapping the second coil, a second section positioned between the first section and the first end, and a third section positioned between the first section and the second end. A part of the first coil extends in the longer length direction along at least one of the second and third sections. An inside area of the first metal plate that overlaps the opening of the first coil is smaller than an outside area thereof that does not overlap the opening of the first coil. With the above configuration, communication distance can be increased.

In the above antenna device, the second end of the slit may be away from the inner edge of the innermost turn of the first coil by a second distance, the outer edge of the outermost turn of the first coil may be away from the outer edge of the first metal plate by a third distance, and the second distance may be larger than the third distance. This can apply more magnetic flux to the first metal plate functioning as an antenna.

In any of the above antenna devices, the maximum value of a fourth distance between the innermost turn of the first coil and the slit in the shorter length direction perpendicular to the longer length direction may be smaller than the maximum value of a fifth distance between the outermost turn of the first coil and the outer edge of the metal plate in the shorter side direction. This can further reduce the size of the substrate on which the first coil is formed.

In any of the above antenna devices, the slit may overlap the axial center of the first coil. This can further increase communication distance.

In the above antenna device, the third section may be longer than the second section. This can further increase communication distance.

In any of the above antenna devices, the second end of the slit may be positioned inside the innermost turn of the first coil. This can further increase communication distance.

In any of the above antenna devices, the third section may include a fourth section extending in the longer length direction and whose one end is connected to the first section, a fifth section extending in the longer length direction and whose one end constituting the second end, and a sixth section extending in the shorter length direction and connecting the other ends of the fourth and fifth sections. This prevents the slit from interfering with a signature field provided on the surface of the first metal plate when the first metal plate is used as a bottom metal plate for an IC card.

In the above antenna device, at least the sixth section may be positioned inside the opening of the first coil. This can further increase communication distance.

In the above antenna device, the maximum value of a width of the opening of the first coil in the shorter length direction at a position crossing the fifth section may be smaller than the maximum value of a width of the opening of the first coil in the shorter length direction at a position crossing the first section. This allows a crank-shaped slit to be disposed at the axial center of the first coil.

Any of the above antenna devices may further include a capacitor pattern disposed at a position overlapping the outside area of the first metal plate and on the side of the shorter length direction perpendicular to the longer length direction, as viewed from the first coil. This allows a resonance frequency to be adjusted by the capacitance of the capacitor. In this case, the capacitor pattern may be away in the shorter length direction from the outer edge of the outermost turn of the first coil by a sixth distance and away in the shorter length direction from the outer edge of the first metal plate by a seventh distance, and the sixth distance may be larger than the seventh distance. This reduces influence that the capacitor pattern has on the characteristics of the first coil. Further, a capacitor including the capacitor pattern may be connected in series or in parallel to the first and second coils. In the latter case, the line length of the first coil may be smaller than the line length of the second coil.

An IC card according to one embodiment of the present disclosure includes: any of the above antenna devices; a second metal plate having a through hole therein; and an IC module disposed in the through hole of the second metal plate. The first and second coils are sandwiched between the first and second metal plates such that the IC module and second coil overlap each other. With this configuration, there can be provided an IC card whose both surfaces are constituted by the metal plates.

In the above IC card, the first metal plate may have a signature field at a position not overlapping the slit. This avoids the slit from interfering with the signature field.

In the above IC card, the signature field may have a first edge extending along the longer length direction of the first metal plate and a second edge extending in a direction different from the extending direction of the first edge, and one of the second and third sections may have a part extending along the first edge and a part extending along the second edge. This can avoid the slit and signature field from overlapping each other even in a case where a linearly extending slit overlaps the signature field.

An antenna device according to a still another embodiment of the present disclosure includes: a first metal plate and a second metal plate overlapping the first metal plate. The first metal plate has a first slit extending in the longer length direction thereof. The first slit has first and second ends positioned at both ends in the longer length direction. The first end of the first slit is opened so as to divide the outer edge of the first metal plate, and the second end does not reach the outer edge of the first metal plate and is terminated at a position away from the outer edge by a first distance. The second metal plate has a through hole therein and a second slit connecting the outer edge of the second metal plate with the through hole. The first slit includes a first section overlapping the through hole, a second section positioned between the first section and the first end, and a third section positioned between the first section and the second end. The first distance is smaller than the longer one of the second and third sections. This enables communication with external devices while reducing the number of components.

In the above antenna device, the width of the second slit may be smaller than the width of the first slit. This can maintain the beauty of appearance when the second metal plate is used as a top metal plate for the IC card.

An IC card according to another embodiment of the present disclosure includes the above-described antenna device and an IC module disposed in the through hole. With this configuration, there can be provided an IC card whose both surfaces are constituted by the metal plates.

What is claimed is:

1. An antenna device comprising:
a first metal plate;
a first coil disposed so as to overlap the first metal plate in a plan view and wound along an outer edge of the first metal plate; and
a second coil disposed inside an opening of the first coil and connected to the first coil,
wherein the first metal plate has a slit extending in a longer length direction of the first metal plate,
wherein the slit has first and second ends positioned at both ends in the longer length direction,
wherein the first end is opened so as to divide an outer edge of the first metal plate,
wherein the second end is terminated at a position away from the outer edge of the first metal plate by a first distance so as not to divide the outer edge of the first metal plate,
wherein the slit includes a first section overlapping the second coil, a second section positioned between the first section and the first end, and a third section positioned between the first section and the second end, and
wherein the first distance is smaller than a longer one of the second and third sections.

2. The antenna device as claimed in claim 1, wherein the third section is larger in length than the second section.

3. The antenna device as claimed in claim 1, wherein a width of the slit is constant.

4. The antenna device as claimed in claim 1, wherein the second end of the slit is positioned inside an innermost turn of the first coil.

5. The antenna device as claimed in claim 4,
wherein the second end of the slit is away from an inner edge of the innermost turn of the first coil by a second distance,
wherein an outer edge of an outermost turn of the first coil is away from the outer edge of the first metal plate by a third distance, and
wherein the second distance is larger than the third distance.

6. The antenna device as claimed in claim 5, wherein the second distance is larger than a pattern width of the first coil.

7. The antenna device as claimed in claim 1, wherein a width of the slit is larger than a width of a space between adjacent turns of the first coil and smaller than a pattern width of the first coil.

8. The antenna device as claimed in claim 1, further comprising a capacitor connected in series to the first and second coils.

9. The antenna device as claimed in claim 1, further comprising a capacitor connected in parallel to the first and second coils,
wherein a line length of the first coil is smaller than a line length of the second coil.

10. An antenna device comprising:
a first metal plate;
a first coil disposed so as to overlap the first metal plate in a plan view; and
a second coil disposed inside an opening of the first coil and connected to the first coil,
wherein the first metal plate has a slit extending in a longer length direction of the first metal plate,
wherein the slit has first and second ends positioned at both ends in the longer length direction,
wherein the first end is opened so as to divide an outer edge of the first metal plate,
wherein the second end is terminated at a position away from the outer edge of the first metal plate by a first distance so as not to divide the outer edge of the first metal plate,
wherein the slit includes a first section overlapping the second coil, a second section positioned between the first section and the first end, and a third section positioned between the first section and the second end,
wherein a part of the first coil extends in the longer length direction along at least one of the second and third sections of the slit, and
wherein an inside area of the first metal plate that overlaps the opening of the first coil is smaller than an outside area of the first metal plate that does not overlap the opening of the first coil.

11. The antenna device as claimed in claim 10,
wherein the second end of the slit is away from an inner edge of the innermost turn of the first coil by a second distance,
wherein an outer edge of an outermost turn of the first coil is away from the outer edge of the first metal plate by a third distance, and
wherein the second distance is larger than the third distance.

12. The antenna device as claimed in claim 10, wherein a maximum value of a fourth distance between an innermost turn of the first coil and the slit in a shorter length direction perpendicular to the longer length direction is smaller than a maximum value of a fifth distance between an outermost turn of the first coil and the outer edge of the metal plate in the shorter side direction.

13. The antenna device as claimed in claim 10, wherein the slit overlaps an axial center of the first coil.

14. The antenna device as claimed in claim 10, wherein the third section is longer than the second section.

15. The antenna device as claimed in claim 10, wherein the second end of the slit is positioned inside an innermost turn of the first coil.

16. The antenna device as claimed in claim 10, wherein the third section includes:
a fourth section extending in the longer length direction, one end of the fourth section being connected to the first section;
a fifth section extending in the longer length direction, one end of the fifth section constituting the second end; and
a sixth section extending in a shorter length direction perpendicular to the longer length direction and connecting another end of the fourth section and another end of the fifth section.

17. The antenna device as claimed in claim 16, wherein at least the sixth section is positioned inside the opening of the first coil.

18. The antenna device as claimed in claim 17, wherein a maximum value of a width of the opening of the first coil in the shorter length direction at a position crossing the fifth section is smaller than a maximum value of a width of the opening of the first coil in the shorter length direction at a position crossing the first section.

19. The antenna device as claimed in claim 10, further comprising a capacitor pattern disposed at a position overlapping the outside area of the first metal plate and on a side of a shorter length direction perpendicular to the longer length direction, as viewed from the first coil.

20. The antenna device as claimed in claim 19,
wherein the capacitor pattern is away in the shorter length direction from an outer edge of an outermost turn of the first coil by a sixth distance and away in the shorter length direction from the outer edge of the first metal plate by a seventh distance, and
wherein the sixth distance is larger than the seventh distance.

21. The antenna device as claimed in claim 19, wherein a capacitor including the capacitor pattern is connected in series to the first and second coils.

22. The antenna device as claimed in claim 19,
wherein a capacitor including the capacitor pattern is connected in parallel to the first and second coils, and
wherein a line length of the first coil is smaller than a line length of the second coil.

23. An IC card comprising:
an antenna device comprising:
a first metal plate;
a first coil disposed so as to overlap the first metal plate in a plan view and wound along an outer edge of the first metal plate; and
a second coil disposed inside an opening of the first coil and connected to the first coil;
a second metal plate having a through hole therein; and
an IC module disposed in the through hole of the second metal plate,
wherein the first metal plate has a slit extending in a longer length direction of the first metal plate,
wherein the slit has first and second ends positioned at both ends in the longer length direction,
wherein the first end is opened so as to divide an outer edge of the first metal plate,
wherein the second end is terminated at a position away from the outer edge of the first metal plate by a first distance so as not to divide the outer edge of the first metal plate,
wherein the slit includes a first section overlapping the second coil, a second section positioned between the first section and the first end, and a third section positioned between the first section and the second end,
wherein the first distance is smaller than a longer one of the second and third sections, and
wherein the first and second coils are sandwiched between the first and second metal plates such that the IC module and second coil overlap each other.

24. The IC card as claimed in claim 23, wherein the first metal plate has a signature field at a position not overlapping the slit.

25. The IC card as claimed in claim 24,
wherein the signature field has a first edge extending along the longer length direction of the first metal plate and a second edge extending in a direction different from the extending direction of the first edge, and
wherein one of the second and third sections has a part extending along the first edge and a part extending along the second edge.

26. An antenna device comprising:
a first metal plate; and
a second metal plate overlapping the first metal plate,
wherein the first metal plate has a first slit extending in a longer length direction of the first metal plate,
wherein the first slit has first and second ends positioned at both ends in the longer length direction,
wherein the first end of the first slit is opened so as to divide an outer edge of the first metal plate,
wherein the second end is terminated at a position away from the outer edge of the first metal plate by a first distance so as not to divide the outer edge of the first metal plate,
wherein the second metal plate has a through hole therein and a second slit connecting an outer edge of the second metal plate with the through hole,
wherein the first slit includes a first section overlapping the through hole, a second section positioned between the first section and the first end, and a third section positioned between the first section and the second end, and
wherein the first distance is smaller than a longer one of the second and third sections.

27. The antenna device as claimed in claim 26, wherein a width of the second slit is smaller than a width of the first slit.

28. An IC card comprising:
an antenna device comprising:
a first metal plate; and
a second metal plate overlapping the first metal plate,
wherein the first metal plate has a first slit extending in a longer length direction of the first metal plate,
wherein the first slit has first and second ends positioned at both ends in the longer length direction,
wherein the first end of the first slit is opened so as to divide an outer edge of the first metal plate,
wherein the second end is terminated at a position away from the outer edge of the first metal plate by a first distance so as not to divide the outer edge of the first metal plate,
wherein the second metal plate has a through hole therein and a second slit connecting an outer edge of the second metal plate with the through hole,
wherein the first slit includes a first section overlapping the through hole, a second section positioned between the first section and the first end, and a third section positioned between the first section and the second end,
wherein the first distance is smaller than a longer one of the second and third sections, and
wherein the IC card further comprises an IC module disposed in the through hole.
